(19) United States
(12) Patent Application Publication
(10) Pub. No.: US 2004/0010453 A1
(43) Pub. Date: Jan. 15, 2004

(54) Method and system for trade of goods, in particular electricity, water, fuel gas and the like

(76) Inventor: Karsten Aubert, Radal (NO)

Correspondence Address: CARELLA, BYRNE, BAIN, GILFILLAN, CECCHI,, STEWART & OLSTEIN, 6 BECKER FARM ROAD, ROSELAND, NJ, 07068, US

(21) Appl. No.: 10/240,834

(22) PCT Filed: Apr. 10, 2001
(86) PCT No.: PCT/NO01/00160

(30) Foreign Application Priority Data
Apr. 13, 2000 (NO) 20001920

(51) Int. Cl. G06F 17/60

(52) U.S. Cl. 705/26

(57) ABSTRACT

A method and a system are described for trade of goods, in particular electricity, water, fuel gas, and the like, and the method is characterised in that a computer, which is connected to a measuring unit for consumption of electricity, water, gas and the like, is arranged by means of a link to be connected to a trading system for the mentioned electricity, water, fuel gas and the like with the computer arranged to be programmed for conditions for the trade. The method and system are applied to tie the unit price for the goods at invoicing, directly to the actual price for the time interval when the goods consumption really occurred, or to carry out changes of the conditions for the goods delivery and the like.

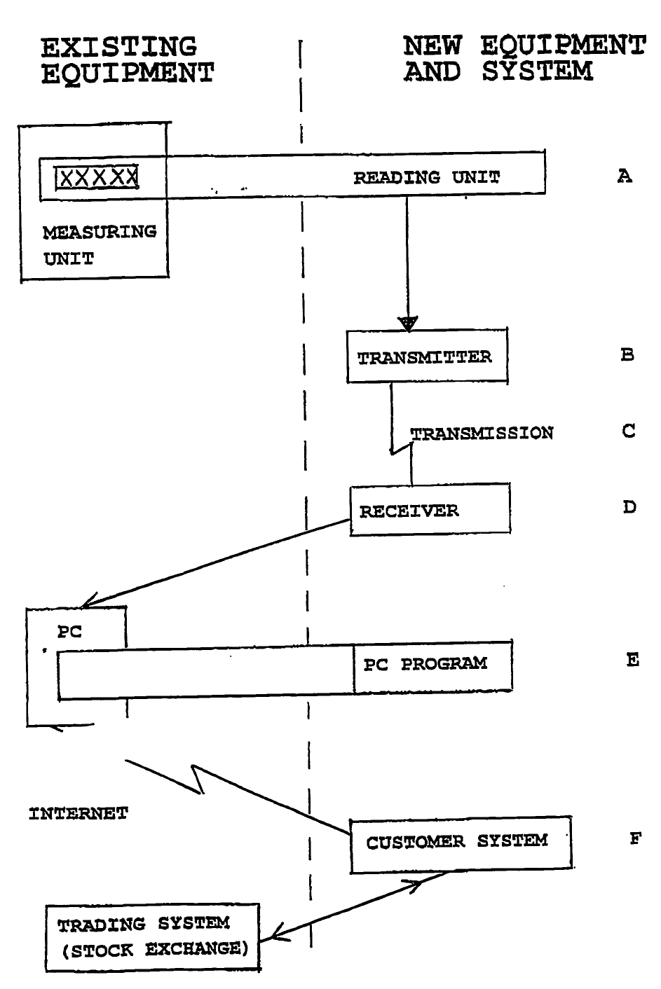

The present invention relates to a method and a system for trade of goods, such as electric power, water, fuel gas and the like, by the use of transfer of information by means of a data network. An application of the method and a system are also described.

Particularly, the invention has to do with the opportunities of customers to operate in an energy market, i.e. to buy electricity for their own use. With customers one is thinking of private persons, companies, public bodies, etc.

Today we have a free energy market, i.e. the customers can buy electricity at any time where it is cheapest. One is no longer dependent on being <<faithful>> to the local electricity producer when it comes to supply of electricity. The costs for use of electricity are primarily divided into two parts, consisting of the price for the electricity itself and a so-called standing charge which is related to the rent of the electricity transmission line system itself. The standing charge is paid regardless, while the energy price is the parameter which one has the greatest possibility to influence. However, this requires that one knows, at all times, which producer supplies the cheapest energy. An energy stock exchange has been set up where it is possible to buy and sell electricity.

Another issue is how the price for consumption, for example of electricity, is set at invoicing. This is effected by calculating an average price over a given time, such as a month etc.

On an energy stock exchange, this price level can fluctuate throughout the day, and as a rule, in such a way that when the consumption is at the lowest (for example during the night), then the price is also at its lowest, and vice versa, the price is highest when the consumption is at a maximum.

Therefore, a typical consumer will not benefit from the actual daily variations in price which occurs during a 24-hour period. Even when the consumer uses electricity during the night when the price is actually at its lowest, he will still be invoiced according to a given mean price.

It is an object of the present invention to provide a new method to obtain a best possible price of the goods for the individual consumer.

Furthermore, it is an object of the invention to make it possible for private individuals, companies, public bodies etc., to get such opportunities to operate in an energy market.

Furthermore, an object of the present invention is to provide a solution where one does not require any new installations, as the invention can be carried out with a simple adaptation/connection of already available appliances and equipment.

Furthermore, an object of the present invention is that the customer shall be able to operate actively in the market at any time on a voluntary basis, or only buy electrical energy at, for example, the daily price.

It is also an object of the invention to provide for a system which makes a <<true-time>> registration possible for later or simultaneous setting of the price and invoicing of a consumption, such as based on registration of a consumption within a given time period, such as for every hour (denoted HOURLY DATA). True-time pricing here means that when the consumption of goods is priced, the unit price valid for the time period the consumption actually happened is used.

HOURLY DATA means that registration and transfer of data during the actual consumption occurs every hour.

To achieve this, a system according to the invention must be provided which implies a connection between the registration of the actual consumption of the goods by a consumer, and a customer system at the supplier of the mentioned goods.

This is achieved by the method according to the invention which is characterised by the following features: that the registration of data from the measuring instrument for the consumption occurs in true-time, that the mentioned data is transmitted to a customer system for storage and any possible further processing of the provided consumer data (such as setting the price), and that the customer system is arranged so that it can communicate with a trading system, such as a stock exchange where the mentioned goods are traded.

According to a preferred embodiment, the price for the consumption of goods is set by the price in the current period when the consumption occurred. And furthermore, the true-time registration of data from the measuring instrument for the consumption, involves a registration for a given period, such as for every hour, whereby hourly data for the consumption is provided.

Further preferred embodiments of the method are described in the dependent claims 3-9.

The system is characterised by a device for reading of the data concerning registration of consumption from the measuring instrument, a transmitter for transmission of the mentioned data to a customer system, and that the customer system is connected to a trading system, such as a stock exchange where the mentioned goods are traded. Further features of the system are described in the claims 11-16.

The method and system are applied to make it possible for the unit price which the customer pays for his consumption of the goods, to be tied directly to the actual unit price at the time of the consumption, and or to changes in the conditions for supply of the goods, changes of goods supplier and the like.

Consequently, a system is provided where the following steps are carried out:

a) automatic reading of a measuring instrument which registers a consumption of goods (such as electricity, fuel gas, water and the like),

b) the measuring result is transmitted to a computer,

c) the computer transmits data continuously or at given time intervals, via a network such as the internet, to a customer register and a trading system,

d) a true-time registration of actual consumption is carried out in the customer system, whereby this registration forms the basis for a later setting of the price and invoicing, and possibly

e) a choice is given to carry out an action, for example entering a new contract for supply.

The invention shall now be explained in more detail with reference to the enclosed figure.

On the left side of the figure, the already familiar elements are described which can be used in the method according to the invention. The first element concerns a typical measuring instrument, for example, an ELECTRICITY METER which can be found in any home, company or institution that use electricity. Additionally, a COMPUTER, i.e. a PC, which most people have access to today, is used. Additionally, an energy stock exchange or similar trading location shall be included. A <<STOCK EXCHANGE>>, see the bottom of the figure, is a well-known area for trading in goods and services, while it is relatively new in connection with energy supply.

To the right in the figure the new elements are given which are applied in the method according to the invention, namely a READING UNIT, a TRANSMITTER, a RECEIVER, a COMPUTER PROGRAM, a NETWORK CONNECTION, a CUSTUMER SYSTEM which is connected to the STOCK EXCHANGE.

An explanation of the individual elements in the new system according to the invention is given below.

The READING UNIT can be comprised of a unit which reads the meter numeral ber on the MEASURING UNIT. This reading unit can be an optical reading unit which reads the numeral in the measuring unit. It is also possible to use an electronic camera which registers the meter numeral and sends it on. Alternatively, one can register every time the last digit on the meter is changed with the aid of a light-emitting diode which lights up certain points on the numeral and registers whether they are white or black (or coloured).

The TRANSMITTER receives signals from the READING UNIT with the signals being transmitted to a RECEIVER connected to the COMPUTER.

The transmission of the signals from the READING UNIT to the TRANSMITTER and further to the RECEIVER:

1) can occur wirelessly according to the same principle which is used for remote control of TV apparatus and similar equipment.

2) can occur by transforming the signals to a frequency that can be transmitted through the building's own system of transmission lines. For example, such a system, in which one uses the existing electric wiring, is used today in certain electronic alarm appliances (for example, electronic baby alarms).

The RECEIVER receives the signals in one of the two ways 1)-2). The signals are transformed and transmitted to the computer by way of a cable to one of the existing contacts in the COMPUTER. The RECEIVER ought to have storage capacity, i.e. a buffer, for a certain amount of data. This is to be able to deliver data that is of sufficient quality in periods when the COMPUTER is shut down or not in operation.

The COMPUTER incorporates a program which transforms the signals from the measuring unit to typical data records. The program must be able to send data by way of a connected network (for example direct line, such as e-mail and the like) or another link to a CUSTOMER SYSTEM which, for example, can lie centrally in a main frame (a server). The customer system means, for example, that one participates in a database set up for customers who wish to use the stock exchange as and when they want. This means that the base for each individual customer contains information about how he wants to buy electricity (or also for example water, fuel gas, and the like) to the unit price of the day (spot-price) or more long term purchases. Furthermore, in the CUSTOMER SYSTEM base, there will be information about how often one shall <<test>> the consumption and under which criteria the stock-broker in the CUSTOMER SYSTEM shall act in the energy stock exchange. The customer's conditions for the trade of goods can be programmed into the computer and be transmitted to the customer system for storage.

Other tasks are possible with the program, such as that it should be standard to be able to see, and get an overview over, statistics and figures of one's own consumption and that one can get prognoses for future consumption dependent on, for example, the outdoor temperature or other parameters.

The CUSTOMER SYSTEM on a main frame (the server) must therefore be comprised of a trading system for the relevant goods (electricity, fuel gas, water, and the like). The customer system registers the customer's consumption at the highest level of detail possible. From these information details, it will be possible to invoice the customer correctly, and the action itself, i.e. the amount of goods which are bought on the stock exchange will be correct at all times. In an electricity market, the prices will vary hour by hour and it is important to make this information available to the customers so that their consumption can be adjusted accordingly. One can for example, save money by running large electricity consuming appliances (dishwashers and washing machines) at points in time where the electricity price is low, for example, at night.

The central elements in the new system according to the invention are the reading unit itself and the customer system (see the figure), and the connection between these elements. Establishing such a customer system according to the invention gives considerable advantages.

The customer system according to the invention collects all demands and wishes from a large number of small customers (consumers). These data will be updated at any time, together with the actual consumption hour by hour.

The customer system will form the basis for buying of electricity, fuel gas, water and the like in large volumes even if each individual electricity customer is small.

All those who wish to buy electricity, fuel gas, etc, on an hourly basis (spot) will be collected in one group of buyers. In a similar way, all those wishing steadier prices (based on a week, month, half-year) will be collected in groups for joint buying on the stock market.

All purchases are based on the customers' own data about actual electricity consumption and own wishes for securing prices. This will make the individual customer independent of the energy companies or external brokers who shall speculate (<<trade>>) on behalf of the customer.

A system arranged in this way, with hourly readings and a joint customer system towards a stock exchange, will for the first time, bake it possible for the customers to benefit from saving electricity, gas, etc., when the goods in reality are at their most expensive in the market.

For example, the hourly prices in the market can be many times higher when one approaches peak demand in the morning or in the afternoon during cold spells than the prices are at other times of the day, for example, during the night.

This can give considerable savings both for the consumer and the suppli rs of goods in that the consumption is reduced during the critical periods and that one knows who is actually saving electricity, and that this can be regulated in the future.

Consequently the invention provides a system that makes it possible for the unit price which the customer shall pay for his consumption of the goods (electricity, water, gas, etc.) (based on hourly data) to be connected directly to when, i.e. the time period, the consumption occurred. The means, for example, that when the goods are consumed between eight and nine o'clock in the morning, the consumption is invoiced according to the real market price between eight and nine o'clock. Furthermore, when the goods are consumed during the night (for example use of washing machines/dishwashers) when the price is at its lowest, the consumption is invoiced also according to the real night-time price.

With the invention, a system is thus provided which gives the consumer an incentive to save, for example, electricity and distribute his consumption over a 24-hour period, something which is a great economic advantage to the consumer himself.

A new possibility, such as this, for a more even distribution of consumption over a 24-hour period is also an advantage to the energy producer/supplier as the peaks in the power production itself can be reduce. Today, the distribution grid for electricity has a limited capacity. Consequently, it is the distribution grid which constitutes the limiting factor in the chain and not the energy production itself when cold periods occur, and the electricity consumption increases.

1. Method for trade of goods, in particular electricity, water, fuel gas and the like, where the data from a measuring instrument for a consumption of mentioned goods are registered, and the registered data are transmitted to a customer system for storage of data, and possible invoicing of mentioned consumption, characterised by the following features;
that the registration of data from the measuring instrument of the consumption occurs in true-time,
that the mentioned data are transmitted to a customer system for storage and possible further processing of the generated consumption data (such as setting of prices), and
that the customer system is arranged to communicate with a trading system, such as a stock exchange where the mentioned goods are traded.

2. Method according to claim 1, characterised in that the setting of the price for the consumption of goods is determined by the unit price during the current period of time in which the consumption occurred, and true-time registration from the measuring instrument of data for the consumption implies a registration for a given time period, such as for every hour, whereby hourly data of the consumption is provided.

3. Method according to claims 1-2, characterised in that the registration is carried out by a meter numeral on the measuring instrument being read optically and the optical signal being transformed to an electronic signal which is transmitted to the customer systems,
and the transmission is carried out wirelessly, or that the signals are transformed to a frequency which can be transmitted by means of a cable network, such as an existing electric wiring network.

4. Method according to claim 3, characterised in that the meter numeral is read and registered by means of an electronic camera which registers, transforms and sends the signal further to the customer system.

5. Method according to claim 3, characterised in that an optical registration for every time the last digit in the instrument's counter changes with the aid of a light emitting diode which lights up certain points on the digit and registers whether they are white or black (or coloured).

6. Method according to one of the preceding claims, characterised in that data are transferred to the customer system by means of a computer.

7. Method according to one of the preceding claims, characterised in that the computer is arranged, by means of an information network such as the internet, to be programmed for conditions for trading according to the wishes of the customer.

8. Method according to one of the preceding claims, characterised in that by means of the customer system, the computer is connected continuously or at given time intervals, up to the trading system (the stock exchange).

9. Method according to one of the preceding claims, characterised in that the trading system is comprised of a subscriber/customer register, said subscriber/customer register comprises a database in which the customer's conditions for activities on the stock exchange are stored.

10. System for trade of goods such as electricity, water, fuel gas, and the like, comprising a measuring instrument in which a consumption of mentioned goods is registered, and a customer system for processing of mentioned data, characterised by
an appliance for reading of data related to the registration of consumption from the measuring instrument,
a transmitter for transmission of mentioned data to a customer system, and
that the customer system is connected to a trading system, such as a stock exchange where the mentioned goods are traded.

11. System according to claim 10, characterised by an appliance for optical reading of the meter numeral on the measuring instrument.

12. System according to claim 11, characterised by an electronic camera for reading of the meter numeral.

13. System according to one of the preceding claims 10-12, characterised in that the reading appliance for the data is connected to the customer system by means of a computer.

14. System according to one of the preceding claims 10-13, characterised in that the computer is arranged, by means of a data network such as the internet, to be programmed for conditions for the trading according to the wishes of the customer, said conditions being stored in the customer system.

15. System according to one of the preceding claims 10-14, characterised in that the computer is, via the customer system, connected continuously or at given time intervals up to the trading system (stock exchange).

16. System according to one of the preceding claims, characterised in that the trading system comprises a subscriber/customer register, said subscriber/customer register comprises a data-base in which the customer's instructions for activities on the stock exchange are stored.

17. Application of method and system according to the preceding claims to tie the unit price of the goods at invoicing, directly to the price which was valid for the time interval when the consumption of the goods actually occurred.

18. Application of method and system according to the preceding claims for changing of conditions for the goods supply and the like.
